(19) United States
(12) Patent Application Publication
(10) Pub. No.: US 2008/0051917 A1
(43) Pub. Date: Feb. 28, 2008

(54) Network Audio Speaker System

(76) Inventor: Jong Sung Lee, Gumi-si (KR)

Correspondence Address: RABIN & Berdo, PC, 1101 14TH STREET, NW, SUITE 500, WASHINGTON, DC, 20005, US

(21) Appl. No.: 11/720,483

(22) PCT Filed: Nov. 29, 2005
(86) PCT No.: PCT/KR05/04026

§ 371 Date: May 30, 2007

(30) Foreign Application Priority Data
Nov. 30, 2004 (KR) 10 -2004-0099212

(51) Int. Cl. H04R 29/00; G06F 17/00; H04R 1/00

(52) U.S. Cl. 700/94

(57) ABSTRACT

The present invention relates to speaker systems and, more particularly, to a network audio speaker system, in which a speaker management system compresses and transmits original audio signals to be reproduced and control signals, and a speaker system, assigned an IP address, decompresses the received signals and reproduces the signals as original MP3 sound, so that only a single UTP (CAT5) cable is used, thus simplifying the line structure, facilitating maintenance, and preventing noise from occurring, and, so that individual or group automatic broadcasting control is possible, thus improving efficiency in emergency broadcasting in case of emergency.

### TECHNICAL FIELD

The present invention relates, in general, to speaker systems and, more particularly, to a network audio speaker system, which uses a single Unshielded Twisted Pair (UTP) Category 5 (Cat 5) cable, so that the lines are simplified, maintenance is facilitated, and noise is prevented from occurring, and which assigns a corresponding Internet Protocol (IP), so that the network audio speaker system is capable of performing individual or group automatic broadcasting control, and is thus efficient for emergency broadcasting, etc. in case of emergency.

### BACKGROUND ART

Generally, a speaker is an acoustic device for converting electrical signals into the vibration of a diaphragm, generating a longitudinal wave in the air, and duplicating a sound wave. Such a speaker is connected to a management system for transmitting electrical signals through a cable.

The management system uses a scheme of connecting an audio speaker cable, which is a dedicated line, to a speaker and transmitting an analog audio signal to the speaker. The management system amplifies a generated sound source through an amplifier (pre-amplifier or power amplifier), and transmits the amplified sound source to the speaker.

That is, various sound sources are primarily controlled through a pre-amplifier that is controllable by voltage, and are converted into output capable of driving the speaker through a power amplifier that generates high power, and the converted sound sources are then transmitted to the speaker.

However, in the prior art, when a plurality of speakers, each installed in a remote place, is intended to be controlled by a single management system, each individual audio speaker cable must be installed to connect from a main line to a corresponding speaker.

Therefore, there are problems in that noise is caused due to the installation of the audio speaker cable, the cost required to install cables increases in proportion to the number of speakers, it is difficult to perform maintenance, lines are complicated, and mobility is poor.

Further, since it is not easy for the management system to automatically control speakers, installed in remote places, individually or in groups, there also occurs a problem in that local emergency broadcasting cannot be sufficiently provided in case of emergency.

### DISCLOSURE OF INVENTION

### Technical Problem

Accordingly, the present invention has been made keeping in mind the above problems occurring in the prior art, and an object of the present invention is to provide a network audio speaker system, which uses a single Unshielded Twisted Pair (UTP) Category 5 (Cat 5) cable, so that lines are simplified, installation cost is low, maintenance is facilitated, noise is prevented from occurring, and, in addition, individual or group automatic broadcasting control is possible.

### Technical Solution

In order to accomplish the above objects, the present invention provides a network audio speaker system, comprising a speaker management system including speaker management software, an audio signal processing unit for converting original audio sound to be reproduced, etc. into audio signals, an audio data transmission unit for converting the audio signals received from the audio signal processing unit into Moving Picture Experts Group (MPEG) Audio Layer-3 (MP3) digital audio data, and assigning a corresponding Internet Protocol (IP) address, and a network control unit for transmitting the audio data received from the audio data transmission unit to the IP address through a network; and at least one speaker system including an audio data processing unit for converting the audio data received from the network control unit into audio signals corresponding to original MP3 sound to be reproduced, an MP3 amplifier for amplifying the audio signals output from the audio data processing unit, a speaker for reproducing the audio signals amplified by the MP3 amplifier as original MP3 sound, and a controller for controlling an entire operation of the audio data processing unit, the MP3 amplifier and the speaker.

Preferably, the audio signals may contain control signals for controlling the speaker system. Preferably, the audio data transmission unit may include a program for compressing the audio signals received from the audio signal processing unit, and the audio data processing unit may include a program for decompressing the compressed audio data received from the network control unit.

Preferably, the speaker management system and the speaker system may be connected to each other through an Unshielded Twisted Pair (UTP) Category 5 (Cat 5) cable. Preferably, the speaker may include one or more types of functions selected from among functions of a digital tuner, a timer, a chime, a Compact Disc (CD) player and an audio mixer.

Preferably, the speaker may include a battery charger to automatically recover power during a power failure.

### ADVANTAGEOUS EFFECTS

The network audio speaker system of the present invention having the above construction is advantageous in that it uses a single UTP (Cat 5) cable, so that lines are simplified, maintenance is facilitated, noise is prevented from occurring, and, in addition, the network audio speaker system is capable of performing individual or group automatic broadcasting control and is thus efficient for emergency broadcasting, etc. in case of emergency.

### BRIEF DESCRIPTION OF THE DRAWINGS

FIG. 1 is a view schematically showing the construction of a network audio speaker system according to the present invention;

FIG. 2 is a block diagram showing the speaker management system of the network audio speaker system according to the present invention;

FIG. 3 is a block diagram showing the speaker system of the network audio speaker system according to the present invention; and

FIG. 4 is a block diagram showing another embodiment of the speaker system of the network audio speaker system according to the present invention.

<Description of Reference Characters of Important Parts>

100: speaker management system

110: speaker management software

120: audio signal processing unit

130: audio data transmission unit

140: network control unit 200: speaker system

210: audio data processing unit 220: controller

230: MP3 amplifier 240: speaker

### BEST MODE FOR CARRYING OUT THE INVENTION

Hereinafter, embodiments of the present invention will be described in detail with reference to the attached drawings.

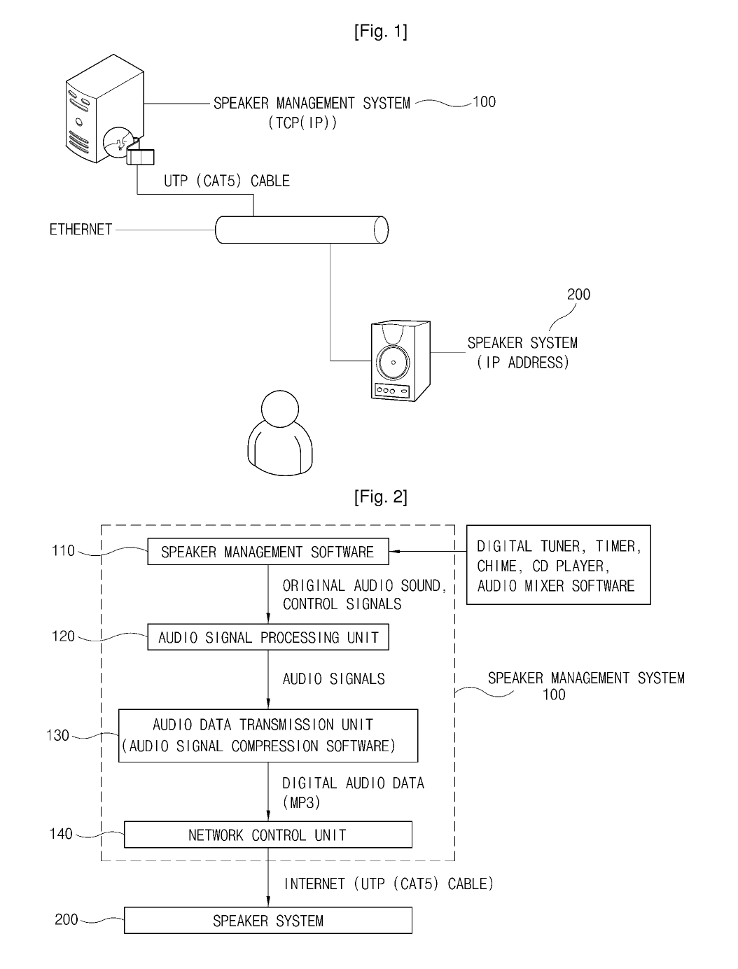

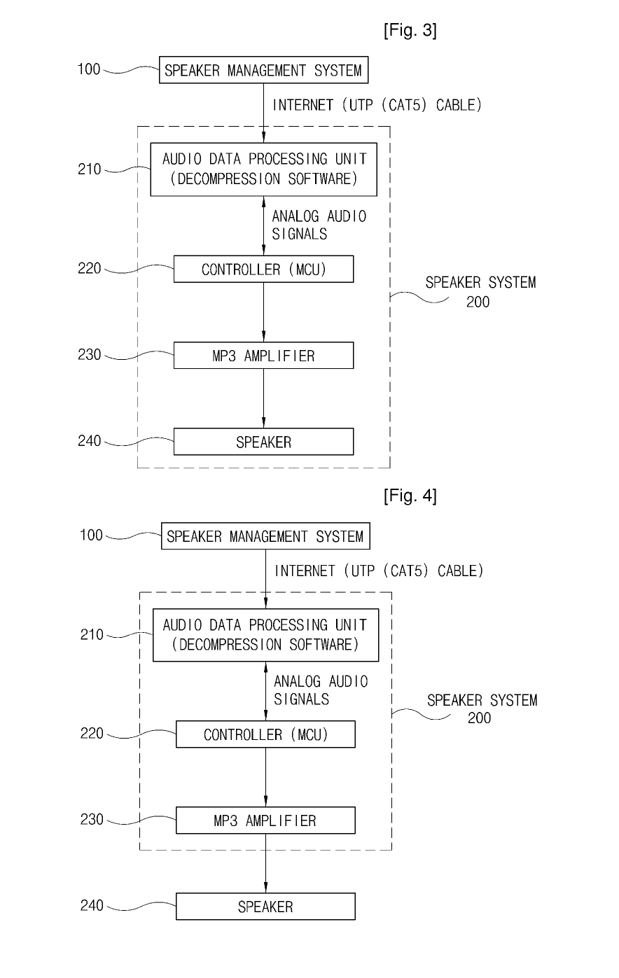

FIG. 1 is a diagram schematically showing the construction of a network audio speaker system according to the present invention, FIG. 2 is a block diagram showing the speaker management system of the network audio speaker system according to the present invention, and FIG. 3 is a block diagram showing the speaker system of the network audio speaker system according to the present invention.

As shown in the Figures, the network audio speaker system of the present invention includes a speaker management system 100 and a speaker system 200.

The speaker management system 100 includes speaker management software 110, an audio signal processing unit 120, an audio data transmission unit 130, and a network control unit 140.

The speaker management software 110 is comprised of software enabling original audio sound and control signals, required for managing the speaker system 200, to be transmitted.

The audio signal processing unit 120 transmits reproduced original audio sound as audio signals using the speaker management software 110.

The audio signals contain control signals for controlling the speaker system 200.

The audio data transmission unit 130 compresses the audio signals received from the audio signal processing unit 120 into Moving Picture Experts Group (MPEG) Audio Layer-3 (MP3) digital audio data using audio signal compression software, assigns an Internet Protocol (IP) address of a corresponding target speaker system 200, and transmits the IP address.

The network control unit 140 transmits the audio data received from the audio data transmission unit 130 to the IP address of the target speaker system 200 through a network.

The speaker system 200 is connected to the speaker management system 100 through the Internet (Ethernet) using an Unshielded Twisted Pair (UTP) Category 5 (Cat 5) cable, and includes an audio data processing unit 210, a controller 220, an MP3 amplifier 230 and a speaker 240.

Further, as shown in FIG. 4, the speaker system 200 can also be applied to a network amplifier including the audio data processing unit 210, the controller 220 and the MP3 amplifier 220, other than the speaker 240.

The audio data processing unit 210 decompresses the audio data received from the network control unit 140 into audio signals corresponding to the original MP3 sound to be reproduced, using audio signal decompression software, and transmits the audio signals.

The MP3 amplifier 230 amplifies the audio signals provided from the audio data processing unit 210 to obtain high output power, and transmits the amplified signals.

Further, the speaker 240 reproduces the audio signals amplified by the MP3 amplifier 230 as original MP3 sound.

The controller (MCU) 220 stores the audio signals in memory and controls the entire operation of the audio data processing unit 210, the MP3 amplifier 230 and the speaker 240.

Meanwhile, since the audio signals transmitted to the speaker 240 contain control signals, the speaker 240 is automatically powered on or off, or the volume thereof is automatically controlled.

The speaker 240 is basically capable of outputting 20 to 30 W stereo audio, in addition to having a power ON/OFF terminal and a volume ON/OFF terminal.

Further, the speaker 240 is provided with a priority function capable of first broadcasting externally applied signals even while broadcasting. In the speaker 240, a battery charger is installed to automatically recover power during a power failure. The speaker uses a separate adaptor as a power supply.

Further, the speaker 240 basically supports functions such as individual selection, group selection, group editing, selection of the entire contents, local selection, or scheduled melody selection, and is also provided with an equalizer function and a stereo function.

Further, the speaker 240 is connected to software for implementing functions such as a digital tuner, a timer, a chime, a Compact Disc (CD) player or an audio mixer.

The digital tuner is used for both Amplitude Modulation (AM) and Frequency Modulation (FM), and is provided with a tuning UP/DOWN switch to be set so that, when the switch is pressed once, the digital tuner is moved by one step, and when the switch is pressed for two seconds or longer, the digital tuner performs an automatic tuning function.

The timer uses melodies having 15 different lengths, and can automatically store or erase data generated for one week.

The chime adopts four scales, two tones, a Westminster chime, or a smooth siren, and is provided with a monitoring function.

The CD player is provided with a play function, a music search function, a pause function, a CD storage function, etc.

The audio mixer has 12 inputs and 2 stereo inputs, and is capable of providing output for respective channels/groups. In each channel, a 4-band tone control function is provided, so that tone can be adjusted according to a user's preference. The audio mixer is provided with an output monitor for each channel.

The detailed construction of the digital tuner, the timer, the chime, the CD player or the audio mixer are well known to those skilled in the art, so that a detailed description thereof is omitted.

The network audio speaker system having the above construction is operated as follows.

The audio signal processing unit 120 of the speaker management system 100 transmits reproduced original audio sound and control signals to the audio data transmission unit 130 as audio signals, using the speaker management software 110.

The audio data transmission unit 130 compresses the audio signals into MP3 digital audio data using audio signal compression software, assigns an IP address of a target speaker system 200, and transmits the IP address.

Next, the network control unit 140 transmits the audio data to the IP address of the target speaker system 200 through the network. The audio data processing unit 210 of the speaker system 200 decompresses the audio data into audio signals corresponding to original MP3 sound to be reproduced, using audio signal decompression software, and transmits the audio signals to the MP3 amplifier 230 through the controller (MCU) 220.

Further, the MP3 amplifier 230 amplifies and transmits the audio signals. Finally, the speaker 240 reproduces the audio signals amplified by the MP3 amplifier 230 as original MP3 sound. The power or volume of the speaker 240 is controlled by the control signals contained in the audio signals.

Therefore, the speaker management system 100 and the speaker system 200 are connected to each other through a single UTP (Cat 5) cable, and the speaker management system 100 can automatically control speakers 240, which are located in remote places and to which respective IP addresses are assigned, individually or in groups.

The network audio speaker system of the present invention can be widely applied to various acoustic devices, through the control of amplifiers using the Internet, as well as the control of remote speakers using the Internet (or Ethernet) communication protocol (Transmission Control Protocol/Internet Protocol: TCP/IP).

Although the preferred embodiments of the present invention have been disclosed for illustrative purposes, those skilled in the art will appreciate that various modifications, additions and substitutions are possible. Therefore, it should be noted that the modifications, additions or substitutions belong to the accompanying claims.

1. A network audio speaker system, comprising:
a speaker management system including,
speaker management software,
an audio signal processing unit for converting original audio sound to be reproduced, etc. into audio signals,
an audio data transmission unit for converting the audio signals received from the audio signal processing unit into Moving Picture Experts Group (MPEG) Audio Layer-3 (MP3) digital audio data, and assigning a corresponding Internet Protocol (IP) address, and
a network control unit for transmitting the audio data received from the audio data transmission unit to the IP address through a network; and
at least one speaker system including,
an audio data processing unit for converting the audio data received from the network control unit into audio signals corresponding to original MP3 sound to be reproduced,
an MP3 amplifier for amplifying the audio signals output from the audio data processing unit,
a speaker for reproducing the audio signals amplified by the MP3 amplifier as original MP3 sound, and
a controller for controlling an entire operation of the audio data processing unit, the MP3 amplifier and the speaker.

2. The network audio speaker system according to claim 1, wherein the audio signals contain control signals for controlling the speaker system.

3. The network audio speaker system according to claim 2, wherein the audio data transmission unit includes a program for compressing the audio signals received from the audio signal processing unit, and the audio data processing unit includes a program for decompressing the compressed audio data received from the network control unit.

4. The network audio speaker system according to claim 3, wherein the speaker management system and the speaker system are connected to each other through an Unshielded Twisted Pair (UTP) Category 5 (Cat 5) cable.

5. The network audio speaker system according to claim 4, wherein the speaker includes one or more types of functions selected from among functions of a digital tuner, a timer, a chime, a Compact Disc (CD) player and an audio mixer.

6. The network audio speaker system according to claim 5, wherein the speaker includes a battery charger to automatically recover power during a power failure.

7. The network audio speaker system according to claim 4, wherein the speaker includes a battery charger to automatically recover power during a power failure.

8. The network audio speaker system according to claim 1, wherein the audio data transmission unit includes a program for compressing the audio signals received from the audio signal processing unit, and the audio data processing unit includes a program for decompressing the compressed audio data received from the network control unit.
